(19) United States
(12) Patent Application Publication
(10) Pub. No.: US 2002/0011951 A1
(43) Pub. Date: Jan. 31, 2002

(54) Portable multimedia tourist guide

(76) Inventors: Gilles Pepin, St-Charles de Drummond (CA); Gerry Gagnon, St-Charles de Drummond (CA)

Correspondence Address: MERCHANT & GOULD PC, P.O. BOX 2903, MINNEAPOLIS, MN, 55402-0903, US

(21) Appl. No.: 09/854,221

(22) Filed: May 11, 2001

(30) Foreign Application Priority Data
May 12, 2000 (CA) 2,308,957

(51) Int. Cl. G01C 21/30

(52) U.S. Cl. 342/357.13; 701/211

(57) ABSTRACT

A portable tourist guide and guiding service. The portable guide has a GPS positioning module for determining its precise position, and a portable computer system. The computer correlates the device's position with relevant touristic information of multimedia format, including digitized audio and visual data. Updatable data storage is provided so that the relevant information is stored in the device and may be updated as needed. A user interface is provided to gather instructions from a user and provide this user with the touristic information.

### FIELD OF THE INVENTION

The present invention relates to the field of tourism and more particularly concerns a portable multimedia tourist guide (hereinafter referred to as MTG) and touristic service using such a guide.

### BACKGROUND OF THE INVENTION

With recent developments in miniaturization and telecommunication technologies, several portable units are presently on the market that could have potential applications in the tourist guiding industry. Several are outlined below with a description of their advantages and disadvantages;

Portable computer and PDA (Personal Digital Assistant) software and accessories: All these products include software and accessories which allow GPS receivers and computers to be connected together to create a navigation and information system. The GPS receiver connects to the portable computer or PDA. The software uses the GPS signal to supply information related to the user position. Several of these products offer functions which are similar to that of a multimedia tourist guide. Such software can be coupled to a road map GIS (Geographic Information System) computers are very practical, whereas the PDA is more portable and costs less. Neither are very robust nor do they meet operational needs. Their software offers very incomplete tourist information and the information is usually only text. The GPS is not an integral part of these devices, so it is very vulnerable to damages caused by shocks bad weather conditions, etc.

Portable GPS receivers:

These portable devices include a GPS receiver and memory storage. These products were designed for various applications including that of the pedestrian in an urban environment. It displays the user's longitude and latitude coordinates. It typically allows the storage of 500 to 750 reference points with an alphanumeric message related to each. However, these devices offer no tourist information.

GPS navigation system with geo-referenced tourist content:

This type of device is the closest to being an audio tourist guide with the GPS receiver integrated into the portable computer. However, it offers very limited tourist content. The device normally offers only the possibility of moving from one point of interest to another. The multimedia aspect is often neglected because these devices do not possess the required peripherals (such as LCD screens and audio out).

Known in the art is the international patent application published under no. W093/20546, which describes an audio tourist guide system. This system allows geographic positioning using a system for capturing satellite signals. It also includes a system of radio frequency receivers, an optical disk reader, a keyboard, a display ( preferably a touch screen), and a voice synthesizer. The device also has a central unit to manage the whole system. One of the main drawbacks of this system is the inflexibility of the optical disk. The information available to the user cannot be updated or changed when needed, and all the necessary information must be included on the disk used, which creates severe restrictions on the quantity and format of the information available. The system is also particularly poorly adapted to persons with visual disabilities because it depends on GPS satellites for geographical localization. Its margin of error is too great to be useful to such persons. Finally, the use of a voice synthesizer implies quite serious functional limitations. The resulting voice effect usually sounds artificial, and is not particularly enjoyable to the user. It is doubtful that a device using such audio means would meet with general public acceptance. Thus, this limits this device in its role as an audio tourist guide. Other inconveniences of this audio tourist guide are its portability (a CD drive or optical guide takes up more space and is heavier than a PCMCIA hard drive or a flash card); autonomy (the optical drive draws more power than a hard drive or flash card) and updatability (optical media eliminates the possibility to give to users dynamic information).

### OBJECTS AND SUMMARY OF THE INVENTION

It is therefore an object of the present invention to provide a more flexible portable tourist guide than the devices described above.

It is another object of the present invention to provide such a device which is easy and pleasant to use for a vacationing tourist.

It is also an object of the present invention to provide a tourist guiding system using a portable tourist guide for providing a tourist with relevant information from a database.

In accordance with the invention, these and other objects are achieved with a portable tourist guide including a GPS positioning module for determining its own geographic position, and a portable computer system. The computer system has data storing means for storing digitized audio and visual data defining touristic information, and correlating means for correlating the geographic position of the tourist guide with relevant touristic information. Updating means for updating the touristic information. The portable tourist guide also includes a user interface having input means, for receiving instructions from a user, and output means, for providing the user with the touristic information.

In accordance with another aspect of the present invention, there is also provided a tourist guiding service, using a portable tourist guide as described above. The service also provides an accessible database, which contains touristic information in the form of digitized audio and visual data. Any portion of the touristic information is downloadable to the storing means of the portable tourist guide.

Other features and advantages of the present invention will be better understood upon the reading of preferred embodiments thereof with reference to the appended drawings.

### BRIEF DESCRIPTION OF THE DRAWINGS

FIG. 1 is a perspective view of a portable tourist guide device according to a preferred embodiment of the present invention.

FIG. 2 is a diagram showing the components of the device of FIG. 1.

FIG. 3 is a diagram showing a first updating mechanism of a device according to the present invention.

FIG. 4 is a diagram showing a second updating mechanism of a device according to the present invention.

FIG. 5 is a diagram showing an example of data distribution on the hard disk of a device according to the present invention.

### DESCRIPTION OF PREFERRED EMBODIMENTS OF THE INVENTION

The portable tourist guide according to preferred embodiments of the present invention is an orientation and information system for persons walking in a high-density urban environment. The device in the preferred embodiments is a type of portable computer with an integrated GPS receiver. The guide's user-friendly interface allows the user to move about without fear of getting lost, to locate points of interests and to get audio-visual information through its LCD screen. The user also has access to lists of restaurants and other services which are cataloged according to specialty, price, etc. Finally, the user can be guided right to the chosen point of service itself. The guide could also create a tourist circuit of places which are of interest to the user.

In order to illustrate its use, let's use the example of a typical tourist who is exploring Paris to discover the vast cultural array of the “City of Light”. The user has just crossed the Petit Pont de la Cité.

Because the portable guide always knows the user's position, it can tell him/her that . . . “you are now on the Ile de la Cité and to your right is the magnificent Notre Dame Cathedral. Would you like to know more?”. If the user answers “Yes”, the system then tells him that “ . . . it was built between 1163 and 1360 to the plans of the Bishop Maurice de Sully. The cathedral is also the geographical center of Paris”. Once he has visited the Cathedral, the user then decides to look for a French restaurant. On the portable guide's LCD screen, the user chooses from the following options: “services” then “restaurants” then “French” then finally “$$”. The MTG then tells the user that “You have three choices within a 1 kilometer radius: Chez Suzy, La Canaille or Chez Marianne”. After the user chooses Chez Suzy, the MTG slowly describes the quickest route to this destination: “Cross over to the rightbank using the Pont d'Arcole; City Hall is to your right . . . Continue down La Rue du Renard . . .”

For the tourist visiting a new city, there is a vast array of useful public and commercial information (police stations, restaurants, hotels, subway stations, dry cleaners, etc.) available on the device according to the present invention. Moreover, it is possible to tap into these commercial services as a source of revenue during the creation of the database. Business people could pay to have their businesses listed in the database.

Portable tourist device according to preferred embodiments

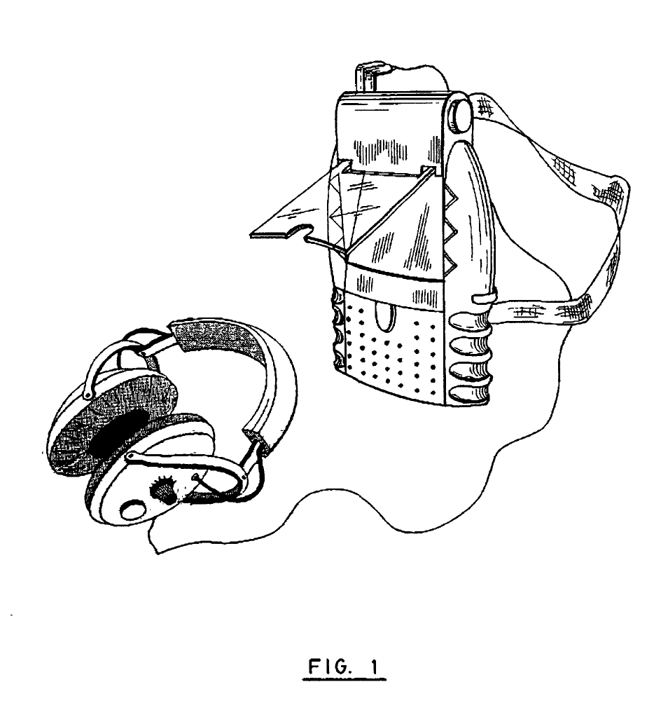

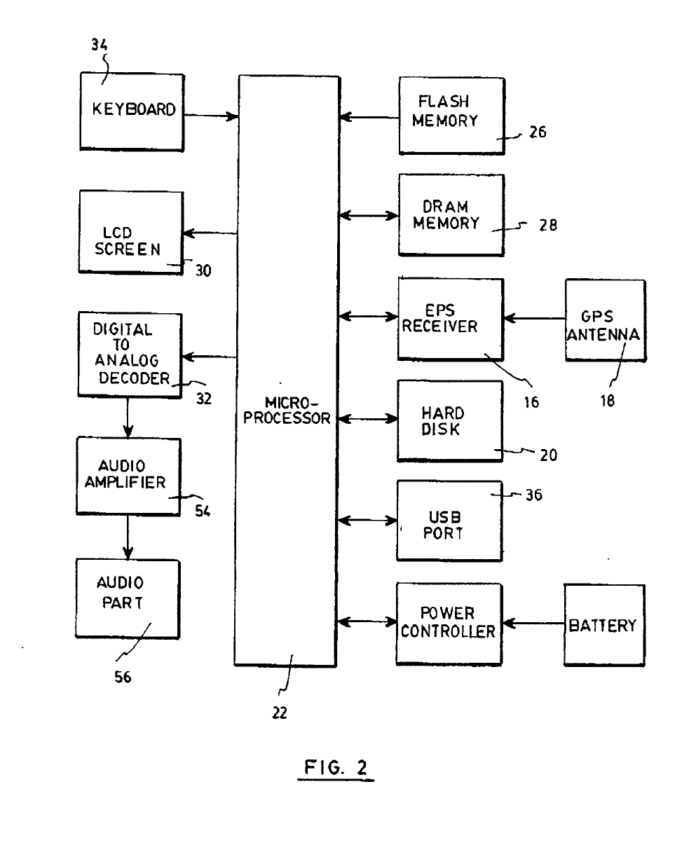

Referring to FIGS. 1 and 2, there is shown and schematized a portable tourist guide device 10 according to a preferred embodiment of the present invention.

The portable tourist guide according to the present embodiment of the invention uses a portable computer system 12, and a GPS positioning module 14 for determining the geographic position of the tourist guide 10, and therefore the position of its user.

The positioning module 14 preferably includes a GPS receiver 16 and an active-type GPS antenna 18. Preferably, the GPS receiver 16 is integral to the computer system 12. In a preferred mode of operation, the antenna 18 captures a signal sent down from the satellite network and, after having amplified it, transmits it to the receiver 16, which decodes the GPS signal and converts it into WGS-84 geographical coordinates. The coordinates and the exact time of acquisition are transmitted to the microprocessor of the computer system 12 in a serial mode. The time of acquisition is simply used to control the length of use. The triangulation system used by cellular phone networks could also be used to position the user but with lesser accuracy.

The portable computer system 12 includes data storing means, for storing digitized audio and visual data defining tourist information. In the preferred embodiment, the data storing means are embodied by a PCMCIA hard disk 20 or a Flash card with enough capacity to store, in several languages, all the necessary data that the system needs. This data includes the operating system, the software, and all the multimedia tourist information such as maps, text, voice, images and possibly sound effects, music and videos.

Also provided are correlating means for correlating the geographic position of the tourist guide with relevant touristic information. This function is accomplished by the microprocessor 22 of the computer system 12 using the appropriate software. In this manner, the guide 10 may provide the user with information on a precise site he is visiting, give directions to a desired destination, recommend restaurants, hotels, etc. The guide may also correlate the touristic to information available with instructions from the user, thereby tailoring the given information to the users' specific requests.

FIG. 2 illustrates the main module 24 of the portable computer system 12 according to a preferred embodiment of the invention. It is however understood that the present invention is in no way limited to this particular module. It includes E the microprocessor 22 run by an algorithm unit, (preferably that which is known under the trademark StrongARM from Intel), Flash memory 26 and DRAM-type memory 28. This is the heart of the system. Using either a Linux or a Windows CE operating system, this module makes the user-device interactive applications work to manage and decode the multimedia touristic information. Moreover, it controls the LCD screen 30, the digital-to-analog decoder 32, the keyboard 34 and the internal system energy use. Flash memory is static memory which stores information when the electric supply to the system is turned off. Its main use is to configure the microprocessor 22 and the operating system when the system starts up. The DRAM memory is dynamic memory which is used by the operating system to store programs, peripheral management software logical variables, etc.

The portable computer system according to the present invention also includes updating means for updating the touristic information stored in the data storing means. This is a highly advantageous feature of the present invention. The digitized audio and visual data defining the touristic information provided by the device of the present invention takes the form of large files by current standards and takes a lot of storage space. It would be impractical to pre-store all the necessary information for a given trip on a CD or other static storage means, especially if the information is multilingual. In addition, touristic information is always changing, and a given static storage device would very quickly become outdated and would need to be replaced.

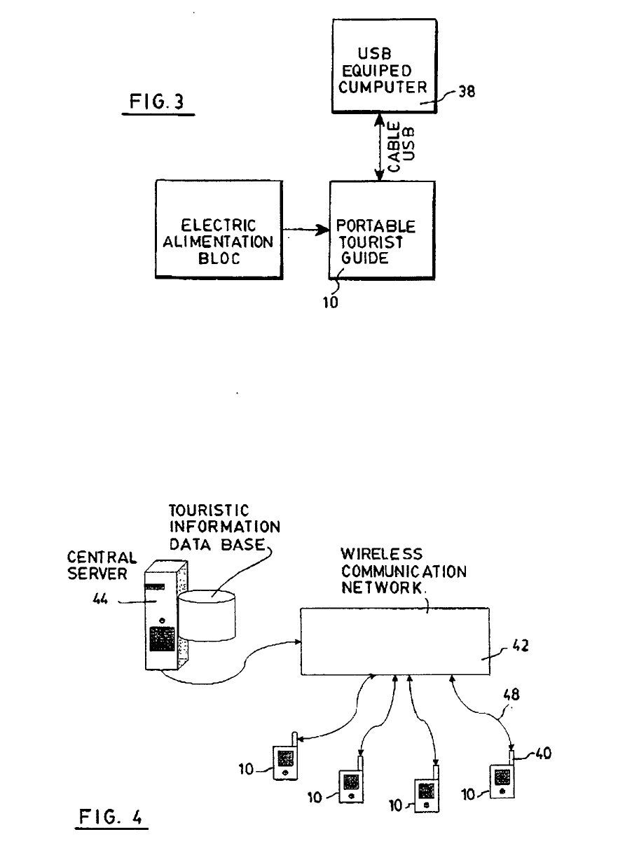

Referring to FIGS. 2 and 3, there is shown a first preferred embodiment of the updating means according to the present invention. For this purpose there is provided a computer port connectable to a computer system for downloading additional touristic information therefrom. Preferably, the computer port is a USB port 36 allowing a user to connect the portable computer system 12 to a USB equipped PC computer 38 using a USB cable. Through appropriate software the user may choose the elements he wishes to download into the portable guide 10 is through the USB cable. The advantage of the USB cable is that its transfer rate is very high (about 12 MB/second) as opposed to 4 MB/second using an infrared port. Moreover, the USB transfer error rate is much lower because of the direct contact between the PC computer and the portable guide. Advantageously, this allows the device to require less memory, since one can download only certain predetermined information instead of downloading the whole database. In addition, the downloaded information may overwrite previous information from the user's earlier part of a trip or a previous trip, which is not needed anymore. This embodiment also allows the batteries to be recharged at the same time as the tourist information is updated.

Referring to FIG. 4, there is shown a second embodiment for the updating means of the present invention. In this embodiment, the touristic information is downloaded remotely through a wireless communication system. For example, the portable guide 10 may be provided with an antenna 40 able to access a wireless communication network 42. A cellular link 48 may advantageously be used in this respect. The network is connected to a central server 44 provided with a touristic information database 46.

In this embodiment, relevant touristic information may be downloaded to the portable guide 10 at any time during the user's trip. As the position of the guide is known at all times via GPS, only relevant information related to that area need be downloaded to the device either automatically or at the user's request. In the case of an automatic download, assume the user is visiting an area of a given city. The portable guide would contain all the information in memory regarding this area. Now, suppose the user decides to explore another part of the city. The device uses its wireless connection to download the information regarding this new area and would overwrite the previous dynamic information in the RAM. Thus, whenever the user moves to a new area, the information is always kept up-to-date in memory.

The user could also use searching features to find specific information. The portable guide would then transmit the request to the central server by the cellular network and this server would then return the information to the user's guide. The portable computer system of the guide could therefore have a large resident memory (fat client) or a less elaborate memory (slim client). This would depend on the quantity and duration of the central-server exchanges with the guide users in the field.

Referring again to FIG. 2, the computer system 12 of the preferred device according to the present invention, also includes a power module, including a power controller 50 and a battery 52. Preferably, high-efficiency rechargeable NiMH battery is used to ensure a constant electrical current to the system. The portable guide is preferably delivered with an AC/DC power adapter which is used to recharge the batteries and to supply the electrical circuit under normal use. This allows the user to download data into the device at the same time the batteries are recharging. The power controller 50 manages the battery charge level and the rate of battery recharge. A power adapter may be provided to be compatible with the electrical standards of the countries in which it is used. The power depends on the speed at which one wants to recharge the NIMH rechargeable batteries.

The guide 10 according to the present invention also has a user interface including inputs such as a keyboard, a touch screen, or other means for a user to provide instructions to the device, and outputs such as an LCD screen and an audio module for providing the user with touristic information. In the preferred embodiment, a graphic display module is provided including an LCD screen control circuit, the LCD screen 30, and the backlight module. Using a user-friendly interface, the screen displays useful visual information such as maps, text, points of interest, the user's position, etc . . . It is possible to adjust the screen contrast with a rotating potentiometer. An audio module is also provided, and includes converting means such as a digital-to-analog decoder 32 for decoding the microprocessor's digital signal into an audible analog signal. The signal is then amplified by an audio amplifier 54 and can be adjusted by means of a rotating potentiometer. The sound signal is 16-bit quality (comparable to a compact disc recording). An appropriate audio output is provided, such as an audio port 56 connected to a set of earphones (see FIG. 1).

In a preferred embodiment of the present invention, the main physical and functional characteristics of the portable guide are as follows:

The system is accurate to 10 m +/−, 95% of the time;

The data storage system has a capacity of between 10 to 20 hours of recording;

The system works within the temperature range of −10 degrees C and +40 degrees C;

The system has a battery charge life of eight hours;

The size of the system is 4″×7″×1″;

The system weighs approximately 500 g;

The system is carried on a shoulder strap.

Example of software for the portable touristic guide according to the invention

The following example examines how the software may be integrated into the portable tourist guide of the invention. We can subdivide this software into four categories:

The operating system;

The application;

The geo-referenced map;

The multimedia content.

When the device is activated, the microprocessor is configured to read a predefined memory address. This address starts up the Linux operating system which manages all the microprocessor internal operations. This version of Linux, ported specifically for the SA-1100, is version 2.2.14. It should be understood however that other operating systems will meet the objects of the invention.

Before start up, the operating system (OS) is compressed on a memory flash card so that it takes up as little space as possible.

Upon start up, it is decompressed into DRAM memory so as to be available to the StrongARM microprocessor. Moreover, an 8 MB of hard disk space is reserved to the OS to be used as virtual memory. It is important to note that all portable guide applications must be Linux OS-compatible when that OS is used.

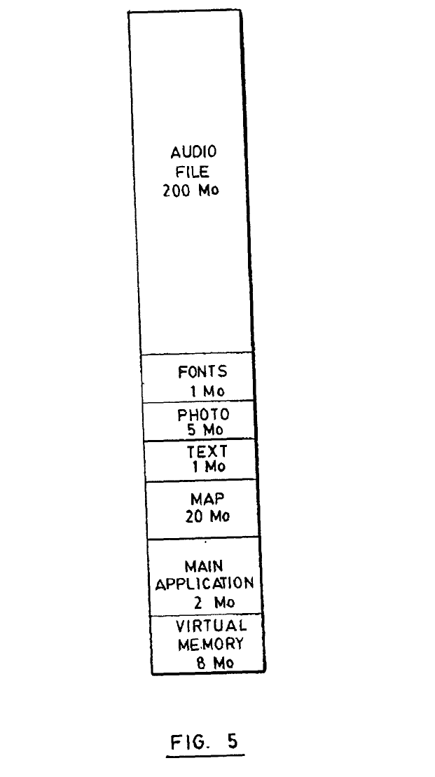

Once the OS has been initialized, the system checks all elements of the guide to make sure that they are functioning correctly. Then, a welcome splash message appears on the screen and the guide downloads the main application into memory. Referring to FIG. 5, there is shown a typical file structure for data stored in a device according to the present invention It includes:

Audio file (200 MB);

Fonts (1 MB);

Photo (5 MB);

Text (1 MB),

Map (20 MB);

Main application (2 MB);

Virtual memory (8 MB)

The main application is preferably programmed in C. The optimized code takes up a relatively small space on the hard drive. This software is used to

Manage the user interface;

Manage events;

Manage all the multimedia components of the system;

Allow the use of the geo-referenced maps;

Read the GPS-sourced data.

In order to carry out these tasks, the application uses software libraries which are task-specific:

Micro-Windows library: manages the graphic display on the LCD screen;

TelConTar library: manages the database found on the geo-referenced maps;

TrueTypeFonts: manages the display of vectorized fonts;

SMIL library: creates the link between a point of interest and the related multimedia content;

JPEG library. manages the image files compressed in this format;

MPEG and SPLAY library manages sound files compressed in MP3 and WAV formats;

C library: standard library used to create applications in C language.

MPG4, AVI Library: manages the audio files compressed in MPEG.

The portable guide incorporates a map of the tourist area where it is being used. Whether in Paris, France or Sydney, Australia, the device can display a very detailed map of the area on its LCD screen. This map, when used in association with the GPS receiver, allows the user to know exactly where he/she is at any given moment. Moreover, it is possible to select a destination and have the MTG guide the user to this point of interest directly or as part of a circuit including other points of interest. Icons on the map represent points of interests (hospitals, stadiums, popular tourist sites, etc.). It is possible to move about on the map using buttons arranged in compass-fashion.

The map is kept in a database containing all the vectors representing streets, lakes, points of interest, etc. It may contain pre-programmed filters which would allow the application to display only selected information. It takes up about 20 MB of hard disk space.

When, for example, a user arrives at a point of interest, the portable guide allows him/her to consult a multimedia tourist database associated with this point of interest. The tourist guide then informs the user in his/her own language of any historical, social, or cultural highlights associated with this point of interest. This information is stored in an MP3 file which may also contain other images, text and possibly even video clips. It takes up approximately 200 MB of hard disk space.

Tourist guiding service according to preferred embodiments

In accordance with another aspect of the present invention, there is provided a tourist guiding service which includes a portable tourist guide as described above and an accessible database containing touristic information. This information is in the form of digitized audio and visual data, and any portion thereof is downloadable to the storing means of the portable tourist guide.

The present invention allows the use of all kinds of multimedia files since the need for space efficiency is greatly decreased, and opens the door to all kinds of interesting information transmission vehicles such as digitized voice recordings, video clips, pictures, detailed maps and images, etc. Advantageously, the use of multimedia features, especially digitized audio recordings instead of a voice synthetizer as with prior art devices, renders the present invention more user friendly and more acceptable to the vacationing user.

Various means for accessing the touristic information may be used in the present invention, such as targeting information contextually-related to the position of the user, doing a theme-based search, providing information related to circuits or general information (resembling very closely a spoken guide), etc. The use of a SMIL (Synchronized Multimedia Integration Language) file structure is an advantageous option since it allows development of flexible content access. The guide according to the invention, is thus a complete information tool because it allows organized navigation through information without the need to access the GPS signal.

Additional features and advantages of the present invention

One can imagine the device of the present invention as being a flexible real-time exploration of tourist sites as well as an optimized path finding tool for guiding the user from point to point. This introduces the notion of planned exploration. Optimization algorithms are used to create these paths, and use a map to show the user the best route to take to get from point A to point B or to get to the tourist site of his/her choice.

Voice recordings are advantageously used because the tourist experience requires a product adapted to the context of vacation time. The recorded voice used is an important factor in making this technology acceptable to the ordinary consumer on holiday.

The device preferably has a two-way client-server relationship which allows either automatic or user-initiated searches of general information stored on a centralized database. It can follow the WAP protocol (telecommunications protocol for mobile devices) which is cellphone-compatible. This would allow the user to connect to an Internet portal (programmed in XML, for example) in order to navigate through extended content or to access a central server.

In another feature, filters may be provided between the device and the user. Thus, the user would be able to find user-centric information (should the user like 18th century history. cooking, politics, or Japanese food, for example).

In the client-server version, content may be updated as often as necessary according to available resident memory. Communication can for example be done using the following networks (depending on the country); SMS (Short Message Service), GSM (Global System for Mobile communication), GPRS (General Packet Radio System), and UMTS (Universal Mobile Telephone System).

The portable tourist guide is preferably equipped with a secondary system, including accelerometers, a gyroscope, an electronic compass, DGPS, which allows the interpolation of movement du ring GPS-signal loss. Moreover, an algorithm allows user-position refinement thereby decreasing the GPS's inherent weakness.

The device of the present invention is particularly well adapted for visually impaired users. In an embodiment specific to such users, the navigation system could be more precise and would allow positional accuracy of 10 m +/−. The DGPS module would be the basis for this secondary system modification. Database content may be entirely available in audio format for these users.

Of course, numerous modifications may be made to the embodiment above without departing from the scope of the invention as defined in the appended claims.

What is claimed is:

1. A portable tourist guide comprising:
a GPS positioning module for determining a geographic position of said tourist guide;
a portable computer system, comprising:
data storing means for storing digitized audio and visual data defining touristic information;
correlating means for correlating said geographic position of the tourist to guide with relevant touristic information;
updating means for updating said touristic information; and
a user interface comprising input means for receiving instructions from a user and output means for providing said user with said touristic information.

2. A portable tourist guide according to claim 1, wherein said GPS positioning module comprises an active-type GPS antenna and a GPS receiver connected thereto.

3. A portable tourist guide according to claim 2, wherein said GPS receiver is integrated to said portable computer system.

4. A portable tourist guide according to claim 1, wherein said data storing means comprises flash memory.

5. A portable tourist guide according to claim 1, wherein said updating means comprise a computer port connectable to a computer system for downloading additional touristic information therefrom.

6. A portable tourist guide according to claim 5, wherein said computer port is a USB port.

7. A portable tourist guide according to claim 5, wherein said additional touristic information overwrites previously stored touristic information.

8. A portable tourist guide according to claim 1, wherein said updating means comprise a wireless communication system for remotely downloading additional touristic information from a network.

9. A portable tourist guide according to claim 8, wherein said wireless communication system comprises a cellular link to said network.

10. A portable tourist guide according to claim 8, wherein said additional touristic information overwrites previously stored touristic information.

11. A portable tourist guide according to claim 1, wherein said correlating means further correlates user instructions received by the input means with said relevant touristic information.

12. A portable tourist guide according to claim 1, wherein said input means comprise a keyboard.

13. A portable tourist guide according to claim 1, wherein said input means comprise a touch screen.

14. A portable tourist guide according to claim 1, wherein said output means comprise a LCD screen.

15. A portable tourist guide according to claim 1, wherein said output means comprise an audio module, comprising:
converting means for converting said digitized audio data into an audio analog signal; and
an audio amplifier for amplifying said audio analog signal.

16. A portable tourist guide according to claim 15, wherein said audio module further comprises an audio port connectable to earphones.

17. A portable tourist guide according to claim 1, further comprising a rechargeable power module.

18. A tourist guiding service, comprising:
a portable tourist guide according to claim 1; and
an accessible database containing touristic information in the form of digitized audio and visual data, any portion of said touristic information being downloadable to the storing means of the portable tourist guide.

19. A tourist guiding service according to claim 18, wherein said accessible database uses a Synchronized Multimedia Integration Language (SMIL) file structure.

20. A tourist guiding service according to claim 18, wherein said touristic information comprises voice recordings.

21. A tourist guiding service according to claim 18, wherein said touristic information comprises video clips.

22. A tourist guiding service according to claim 18, wherein said touristic information is available in a plurality of languages.
